(19) United States
(12) Patent Application Publication
(10) Pub. No.: US 2025/0010256 A1
(43) Pub. Date: Jan. 9, 2025

(54) CAPSULES AND METHODS FOR MIXING MULTIPLE SUBSTANCES

(71) Applicant: Capsulab Ltd, Ramat Gan (IL)

(72) Inventors: Dov MEIRZON, Even-Yehuda (IL); Gal SAAR, Shoham (IL)

(73) Assignee: Capsulab Ltd, Ramat Gan (IL)

(21) Appl. No.: 18/709,534

(22) PCT Filed: Nov. 14, 2022
(86) PCT No.: PCT/IL2022/051215

§ 371 Date: May 13, 2024

Related U.S. Application Data
(60) Provisional application No. 63/279,120, filed on Nov. 14, 2021.

(51) Int. Cl. B01F 35/71; B01F 31/65; B01F 35/30

(52) U.S. Cl. CPC B01F 35/7131; B01F 31/65; B01F 35/7174; B01F 2035/351

(57) ABSTRACT

A capsule for mixing multiple substances, comprising: a main chamber; a main piston fitted therein; a mixer rod passing through the main piston; a mixer element disposed at an end of the mixer rod; an elongated chamber having an exit opening and containing a slidable container filled with an ingredient substance; and a protrusion mechanically mounted in proximity to the exit opening; wherein when a container piston of the slidable container is pushed, the slidable container is moved inside the elongated chamber to be broken by the protrusion; and wherein when the container piston is further pushed, the container piston is moved inside the slidable container thereby pushing the ingredient substance through the exit opening of the elongated chamber into the main chamber for mixing by the mixer element.

### RELATED APPLICATION/S

This application claims the benefit of priority of U.S. Provisional Patent Application No. 63/279,120 filed on Nov. 14, 2021, the contents of which are incorporated herein by reference in their entirety.

This application is also related to PCT Patent Application No. IL2019/051276 filed 22 Nov. 2019 (Attorney Docket No. 79467), to PCT Patent Application No. IL2021/050635 filed 27 May 2021 (Attorney Docket No. 87463), to U.S. Provisional Application No. 63/163,990 filed 22 Mar. 2021 (Attorney Docket No. 86659), and to U.S. Provisional Application No. 63/167,691 filed 30 Mar. 2021 (Attorney Docket No. 87402), the contents of which are incorporated herein by reference in their entirety.

### BACKGROUND

The present invention, in some embodiments thereof, relates to systems and methods for mixing and preparing formulations, and more specifically, but not exclusively, to capsules and methods of extracting substances within.

In recent years, consumers of toiletries, personal care items, food additives, nutritional supplements, and pharmaceutical compositions are expressing a growing need for custom-made, personalized, modular, and/or do-it-yourself preparations of ingredients. To meet this need, various capsules have been designed that contain separate compartments for different substances and a mechanism for mixing those substances when desired. Examples of such capsules are disclosed in the above-identified applications by the same inventors.

The capsules described in the above-identified applications generally feature a main chamber and a plurality of tubular chambers that are either peripheral to the main chamber or incorporated within the main chamber. The tubular chambers include separate ingredient substances. To prepare a custom-made composition, a user attaches the capsule to a mixing machine, uses a pushing rod from the mixing machine to displace each of the desired substances from the tubular chamber into the main chamber, and mixes the substances within the main chamber.

### SUMMARY

According to an aspect of some embodiments of the present invention there is provided a capsule for mixing multiple substances, comprising: a main chamber (101); a main piston (105) fitted in the main chamber (101); a mixer rod (106) which is passing through the main piston (105); a mixer element (107) disposed at an end of the mixer rod (106); an elongated chamber (120) having an exit opening (121) and containing a slidable container (130) filled with an ingredient substance; and a protrusion (122) mechanically mounted in proximity to the exit opening (121); wherein when a container piston (131) of the slidable container (130) is pushed, the slidable container (130) is slidingly moved inside the elongated chamber (120) to be broken by the protrusion (122); and wherein when the container piston (131) is further pushed, the container piston (131) is moved inside the slidable container (130) thereby pushing the ingredient substance through the exit opening (121) of the elongated chamber (120) into the main chamber (101) for mixing by the mixer element (107).

Optionally, the container piston (131) is sealing one end of the slidable container (130) and a breakable seal (132) is sealing another end of the slidable container (130), and the breakable seal (132) is broken by the protrusion (122).

Optionally, the protrusion (122) is mounted on the elongated chamber (120).

Optionally, the protrusion (122) is positioned at a distal end of the elongated chamber (120).

Optionally, the protrusion (122) is pointing towards the inside of the elongated chamber (120).

Optionally, the protrusion (122) is a sharp element which includes at least one of a sharp tip and a sharp edge.

Optionally, the at least one elongated chamber (120) is fluidly connected to the main chamber (101) via the exit opening (121).

Optionally, the elongated chamber (120) is one of a plurality of elongated chambers, each having one of a plurality of a slidable containers configured therein and filled with an ingredient substance.

Optionally, the main piston (105) having an aperture (115) therealong and the mixer rod (106) is passing through the aperture (115)

Optionally, the mixer rod (106) includes a first end and includes a second end and wherein a torque adapter (108) is disposed at the distal end thereof and the mixer element (107) is disposed at the proximal end thereof.

Optionally, the main chamber (101) having a first end (112) and a second end (111) and the main piston (105) and the mixer element (107) are separately displaceable relative to the first and second ends and relative to each other.

Optionally, the main chamber (101) having a first end (112) and a second end (111), and the aperture (115) is passing from a first end of the main piston (105) facing the first end (112) to a second end of the main piston facing the second end (111).

Optionally, the mixer element (107) is arranged within the main chamber (110) between the main piston (105) and the second end (111).

Optionally, the at least one elongated chamber (120) is peripheral to the main chamber (101).

Optionally, the main piston (105) comprises a plurality of cavities, each cavity is one of the elongated chambers (120).

Optionally, the protrusion (122) is shaped as a hollow cylinder.

Optionally, the protrusion (122) is shaped as a hollow cylinder with a bevel tip.

Optionally, the protrusion (122) is shaped as a hollow cylinder which is sliced with two diagonal cuts.

Optionally, the exit opening (121) is located at the center of the protrusion (122).

Optionally, the protrusion (122) is disposed inside the elongated chamber (120).

Optionally, the container piston (131) includes a cavity shaped to accommodate the protrusion (122).

Optionally, the elongated chamber (120) and the slidable container (130) are cylindrical.

Optionally, the protrusion (122) is breaking a sheet covering a distal opening of the slidable container (130).

Optionally, the exit opening (121) includes a passage (124) which is fluidly connected to the main chamber (101).

More optionally, the passage comprises a groove on an inner surface of the at least one elongated chamber (120) passing from a distal end of the elongated chamber (120) to a proximal opening of the elongated chamber (120).

Optionally, the container piston (131) is sealing a proximal end of the slidable container (130), a breakable seal (132) is sealing a distal end of the slidable container (130), and the container piston (131) is pushed distally.

More optionally, the exit opening (121) is located at a distal end of the elongated chamber (120) relative to the slidable container (130).

Optionally, the elongated chamber (120) further includes an entry opening (123) wherein the slidable container (130) is inserted.

Optionally, the mixer rod (106) includes a first end and includes a second end wherein the mixer element (107) is disposed, and wherein a distal end of the elongated chamber (120) is facing the second end of the mixer rod (106).

Optionally, the mixer rod (106) includes a first end and includes a second end wherein the mixer element (107) is disposed, and wherein a distal end of the elongated chamber (120) is facing the first end of the mixer rod (106).

Optionally, the exit opening (121) of the elongated chamber (120) is sealed by a chamber breakable seal.

More optionally, the slidable container (130) includes a container protrusion pointing towards the chamber breakable seal, so when the slidable container (130) is slidingly moved inside the elongated chamber (120), the chamber breakable seal is broken by the container protrusion.

Optionally, the elongated chamber (120) includes a breaker element structure disposed therein, the breaker element structure includes the protrusion (122) on one end, and a second protrusion on another end.

Optionally, the movement of the container piston (131) along the slidable container (130) is parallel to the movement of the main piston (105) along the main chamber (101).

According to an aspect of some embodiments of the present invention there is provided a method for mixing multiple substances, comprising: pushing a container piston (131) of a slidable container (130) filled with an ingredient substance, so that the slidable container (130) is slidingly moved inside an elongated chamber (120), and a protrusion (122) mechanically mounted in proximity to an exit opening (121) of the elongated chamber (120) is breaking the slidable container (130); and further pushing the container piston (131) so that the container piston (131) is moved inside the slidable container (130), and thereby pushing the ingredient substance through the exit opening (121) into a main chamber (101) of a capsule (100); wherein the capsule (100) includes a main piston (105) fitted in the main chamber (101), a mixer rod (106) which is passing through the main piston (105), and a mixer element (107) disposed at an end of the mixer rod (106).

According to an aspect of some embodiments of the present invention there is provided a mechanism for dispensing substances, comprising: an elongated chamber (120) having an exit opening (121) and containing a slidable container (130) filled with an ingredient substance; and a protrusion (122) mechanically mounted in proximity to the exit opening (121); wherein when a container piston (131) of the slidable container (130) is pushed, the slidable container (130) is slidingly moved inside the elongated chamber (120) so that the slidable container (130) is broken by the protrusion (122); and wherein when the container piston (131) is further pushed, the container piston (131) is moved inside the slidable container (130) thereby pushing the ingredient substance through the exit opening (121) of the elongated chamber (120) into a main chamber (101) of a capsule (100); wherein the capsule (100) includes a main piston (105) fitted in the main chamber (101), a mixer rod (106) which is passing through an the main piston (105), and a mixer element (107) disposed at an end of the mixer rod (106).

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the present disclosure may be practiced.

In the drawings:

FIGS. 1A-1D are schematic drawings of a capsule according to some embodiments of the present invention;

FIGS. 2A-2D are section view drawings of a capsule having internal elongated chambers, according to some embodiments of the present invention;

FIGS. 3A and 3B are views of some of the component of the capsule of FIG. 2A, according to some embodiments of the present invention;

FIG. 4 is a section view drawings of a capsule having internal elongated chambers and peripheral elongated chambers, according to some embodiments of the present invention;

FIG. 5 is a section view drawings of a capsule having only peripheral elongated chambers, according to some embodiments of the present invention;

FIGS. 6 and 7 are section view drawings of capsules having reversed internal elongated chambers, according to some embodiments of the present invention;

FIGS. 8A and 8B are section view drawings of a capsule having dual seals, according to some embodiments of the present invention;

FIG. 8C is an exploded view of some of the component of the capsule the capsule of FIG. 8A, according to some embodiments of the present invention;

FIGS. 9A and 9B are section view drawings of a capsule having a sharp element structure, according to some embodiments of the present invention; and

FIGS. 10A-10E are drawings of exemplary configurations of breaker elements and breakable seals, according to some embodiments of the present invention; and

FIG. 11 is a section view drawing of a capsule having a small container inside a large container, according to some embodiments of the present invention.

### DETAILED DESCRIPTION

The present invention, in some embodiments thereof, relates to capsules and methods of mixing multiple substances therein, and more specifically, but not exclusively, to systems and methods for mixing and preparing formulations for consumer use.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, will control. In addition, the materials, methods, and examples are illustrative only and are not intended to be necessarily limiting.

According to embodiments of the present disclosure, a mechanism for penetrating a container and extracting substance from the container in one continuous motion is introduced.

A capsule is provided for mixing substances. The capsule includes a main chamber, a mixer rod comprising a mixer element for mixing fluids in the chamber, and a piston is fitted in the chamber, optionally having an aperture through which the mixer rod passes. The capsule also includes at least one elongated chamber, each configuring within a slidable container containing an ingredient substance. Multiple slidable containers may include different substances that are ingredients of a formulation. A protrusion (or breaker element) is mechanically mounted in proximity to the exit opening of the elongated chamber. The slidable container may be sealed by a container piston on one end, and by a breakable seal on another end.

The capsule may be fixable to a mixer device, which is connecting with the mixer rod for example via a torque adapter, and capable of moving the mixer element, linearly, rotationally and/or both. The mixer device may also comprise a plurality of pushing rods, which are capable of applying force on the capsule.

When the container piston is pushed, two subsequent actions are taking place. First, the slidable container is moved inside the elongated chamber so that the slidable container, or a breakable seal of the slidable container, is broken by the protrusion/breaker element. Then, the container piston is moved inside the slidable container thereby pushing the ingredient substance through the exit opening of the elongated chamber into the main chamber of the capsule. Producing both actions via one continuous pushing motion, significantly simplifies the mechanism required for these actions.

Once the ingredients are within the chamber, they are mixed with the mixer element, to form a formulation.

Unlike some of the capsules described in the above-identified applications, the capsules described in the present disclosure may be assembled in a process which is separated from the process of filling the ingredient substances. The slidable containers may be filled with ingredient substances and sealed independently from each other and from their placement inside the capsule. This provides several advantages related to flexibility, supply chain and costs. This allows a choice of material for each slidable container based on each ingredient substance. A slidable container may be filled at a different location and/or by a different entity than the capsule, for example by the producer of the ingredient substance. Therefore, the assembly of the capsule (for example a customized capsule) may be done in a non-sterile environment, since the ingredient substances are pre-sealed inside the slidable containers. This may significantly reduce the cost of capsule assembly, and improve quality assurance and reliability control processes. Also, the flexibility created by the separation of these processes may help solve issues of substance regulations, for example when some substances are more controlled in some jurisdictions.

Personalization of any type of preparation and/or customized mixture may be set-up by user preferences (manually or automatically by diagnosis) or may be set-up by an integrated diagnostic tool recommendation. For example, a capsule may contain 9 different raw substances that are stored separately and hermetically. In such examples, 8 substances are stored in the slidable containers and a base substance is stored in the chamber. The final product that is produced may be any one of thousands of different final compositions of formulation, made from the same capsule.

Since the capsule provides, in exemplary embodiments, hermetic storage and full separation between the ingredients with sealed containers (prevention of exposure to oxygen nor light before use and between uses), many kinds of ingredients that are unstable and regularly may not be used in such preparations (since they are not functional and practically do not give any value), may be used effectively with the capsule's fresh preparation. Users may personalize and determine mixture-ratios of any supportable mixable raw-materials (powder, liquid and gas).

Unlike pre-prepared mixtures, in which the exact ratios are undisclosed, the formulation is transparent to customers and may be viewed (when applicable) on the capsule or by platform-application.

The capsule design supports a wide range of raw materials and ingredients, liquids, semisolids (gels), gases and solids (powders), some of which are potentially unstable or incompatible. For example, these ingredients are sensitive to oxidation (air), to light (photosensitive) or may react and/or alter solubility of each other.

In some embodiments, the capsule design supports changeable quantities of raw materials inside each slidable container. It is also possible to partially fill in advance tubes with smaller quantities of ingredients. The capsule and mixer device design supports flexible and changeable feed-tube dimensions (even without scale-up or scale-down considerations). In some embodiments, the device allows preparation of small fresh batches (continuously) by mixing each time only part of each ingredient according to a user's parameters, and/or creation of different preparation types by selectively using only some of the ingredients. The mixer device allows one-time preparation or multiple preparations per capsule.

Since the capsule contains all ingredients inside the receptacles and not separately, there is no need for the user to manage ingredients separately and to level his supplies for specific optional formulas. Since the capsule contains an integral mixer inside, and since the capsule is external to the mixer device, the mixer device may be used repeatedly with no need of cleaning in between capsules. The mixer device may not require any setup by the user. The device may provide ready preparations within a very short time. Most of the mixture types may be ready within 30 to 60 seconds from turning on the device.

The preparations that may be made using the capsules and mixer device include, for example, Toiletries—personal hygiene for washing and preventing unpleasant smells such as soap, shampoo, deodorants and perfumes, Personal care—for beautification use (skin care, hair care, cosmetics) and/or preparations for dermatology (derma-cosmetics), Food additives—such as substances added to food to preserve flavor or enhance its taste, appearance, or other qualities, Nutritional supplements—for example taken orally, and usually contains one or more dietary ingredients (vitamins, minerals, herbs, amino acids, and enzymes), Pharma—such as medications or drugs, homeopathy, oral care, or dental preparations and Drinks—such as a cocktail made from different alcoholic and/or non-alcoholic liquids.

For example, the device may be used to create hair dyes that are made in specifically selected colors and/or shades. A hair dye capsule may include ingredients in different colors that are sealed inside the receptacles of the capsule. According to the selected color, a specific amount of each ingredient is inserted into the main chamber to create the desired color. The device may be used at home by the end user to create a different color of hair dye according to the user's choice, or may be used for example at a hair salon, to provide a different color of hair dye for each costumer.

For another example, the device may be used to create personalized medication for a patient. A medication capsule may contain several active pharmaceutical ingredients (APIs) and/or supplements, each stored inside one of the receptacles of the capsule. A medication and/or a mix of medications may be prepared for a patient, based for example on specific physician prescription and/or real-time measurements of a patient's medical data. A mix with the right doses and combination of drugs may be prepared for a specific patient at a specific time, and may be optimized and/or modified accordingly, by adjusting the quantity extracted from each receptacle into the chamber. This provides personalized, precise, on-demand medications, and/or a medication mix which is easier to take than multiple separate medications, and may also improve adherence of patients.

For another example, the device may be used to create a preparation (such as a cream) from pre-formulation ingredients. Each of the slidable containers of a capsule may contain one pure ingredient or a mix of ingredients and/or additives, which are only raw materials and not formulations by themselves. When combined and mixed, the ingredients are turned into a formulation. For example, a water based ingredient and an oil based ingredient may be mixed to create a cream. In addition to modularity and personalization, this may reduce the required regulatory requirements, as the ingredients are not considered a formulation, such as cosmetic products, and potentially reduce cost.

Use of the capsules and mixer device may provide solutions to several needs of consumers. Users may want to have products that are self-prepared in real time, for example for reasons of freshness by mixing their ingredients just before use, minimizing the use of preservations and/or sensitive active raw materials that must be stored in sealed tubes with no contact with air/light for preventing oxidation or other instability reaction (for example antioxidants and/or vitamins). The capsule preserves chemical freshness by preventing instability on a molecular level (molecular change), physical freshness by preventing phase separation (such as with oil & water), biological freshness by preventing active ingredient loss of activity, and microbiological freshness (vegan ingredients and/or saving preservatives) by preventing product contamination and microorganisms growth. Users may want to choose ingredients having specific characteristics, for example, vegan (doesn't contain any animal products and/or doesn't contain products that were tested on animals) and/or organic (certified by an authorized certification organization). Users may want to use products that have a “green” product life-cycle (no disposables). Users may want to have products that are custom made and/or personalized specifically for them. Users may want to control color, odor level, active ingredients ratios, sunscreens addition (and other personal care products) and/or any self-determined desired ratio of raw ingredients. Users may want to choose between available preparations formulas, define new formulas for their own use, use social network or the Internet to download a formula, use diagnostic tools with interfaces that support recommended formulas according to the user's special needs (such as skin analysis by camera scan) and/or use artificial intelligence (AI) which may provide deeper level of formulas recommendations and deeper insights about the user's needs.

The application may provide the user with the ability to use other users' data, insights and recommendations of formulas and treatments' results that are shared in large scale through social media and web-based communities and/or to connect and exchange data, creating opportunities for more direct integration of the physical world to other users, resulting in efficiency improvements and economic benefits.

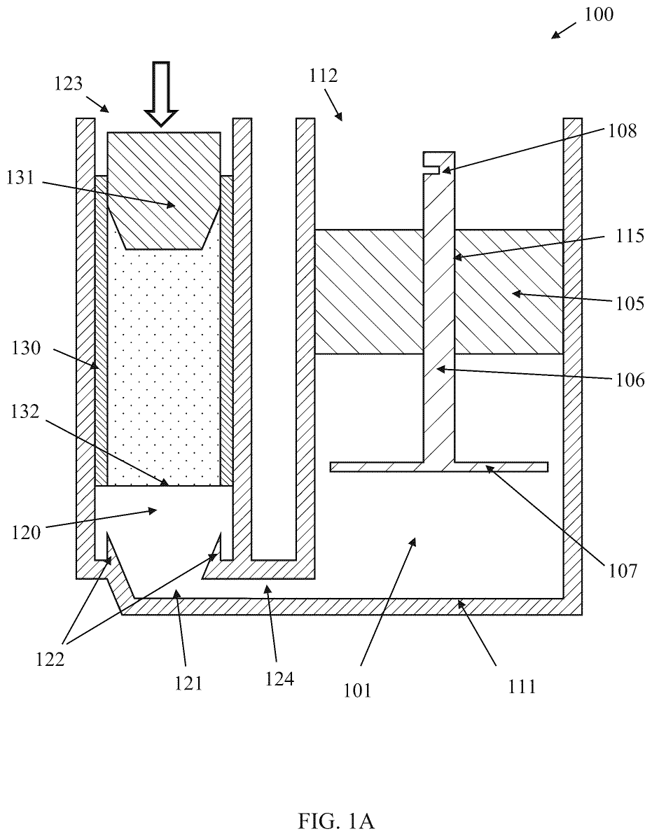

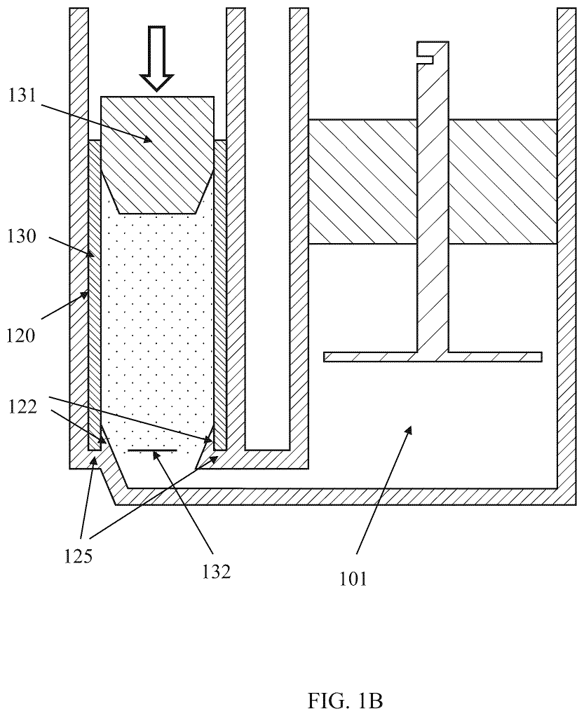

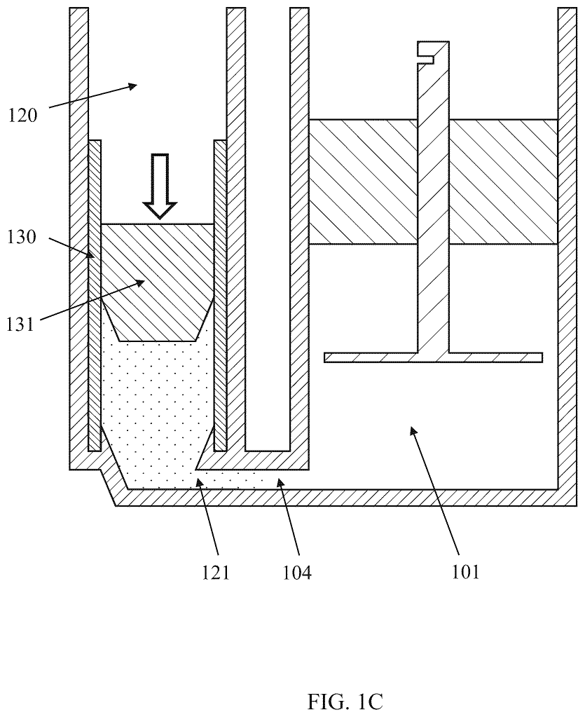

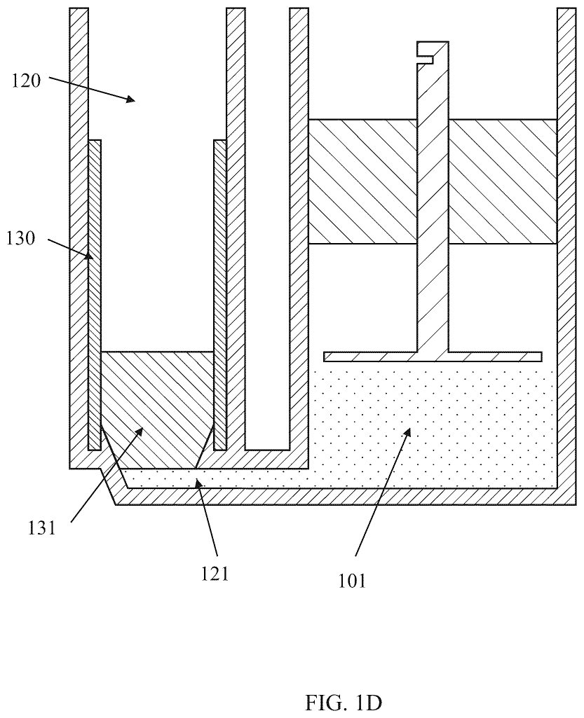

Referring now to the drawings, FIGS. 1A-ID are schematic drawings of a capsule 100, according to some embodiments of the present invention. Capsule 100 includes a chamber 101, having a first end 112 and a second end 111, and into which ingredients for a formulation may be dispensed and mixed.

As used in the present disclosure, the “first end” is the end that engages with the mixer device, and the “second end” is the end adjacent to the mixer element and through which a mixed formulation is dispensed. As used in the present disclosure, the terms “top” and “bottom” are used to refer to the orientation of the first end 112 and second end 111, relative to a floor, when the capsule 100 is engaged with the mixer device. For example, in the capsule of FIGS. 1A-1D, the “first end” is on the “top” and the “second end” is on the “bottom.”

Capsule 100 further includes a piston 105 fitted in the chamber 101. The piston 105 has a first end facing the first end 112 and a second end facing the second end 111. The piston 105 is generally cylindrical, seating in a fluid-tight fashion against the walls of chamber 101, and has an aperture 115 through which a mixer rod 106 passes. The aperture 115 is passing from the first end of the main piston 105 to the second end of the main piston 105.

Mixer element 107 is arranged within chamber 101 between the piston 105 and the second end 111, and may include a plurality of blades. The mixer element 107 is disposed at a second end of mixer rod 106. Mixer rod 106 includes a torque adapter 108 for connecting to a linear and/or rotational actuator of a mixer device. Mixer element 107 and piston 105 are separately displaceable relative to main chamber 101 and relative to each other along the axis of mixer rod 106.

Mixer element 107 may be of any shape or type, structure and/or material, for example for different types of preparations. Different preparation types (made of liquids or liquids and powder) that are mixed inside the chamber 101 have different viscosities and levels of stickiness. For example, hair color preparations are easier to mix effectively than many kinds of creams, whose ingredients have a higher viscosity. The same is true for syrups of nutritional supplements and/or food additives, for which some of their ingredients are relatively sticky. The choice of mixer elements type and/or blades width is influenced by the type of preparation ingredients to achieve effective process (homogeneous preparation and quick mixing).

Chamber 101 also optionally includes a base substance. The base substance may be a relatively inert material, such as a cream, into which other ingredients are mixed. The base substance may be an ingredient of all formulations made with the capsule 100, and thus may be stored in the chamber 101, without requiring an additional step of inserting the base substance into the chamber 101. In addition or in the alternative, the base substance is a substance that is crystallized when refrigerated, such as a substance based on petroleum jelly, which cannot be easily extracted from containers. The crystallization may be reversed when other ingredient substances are mixed with the base substance. The base substance may also, be, for example, a powder.

Capsule 100 also includes an elongated chamber 120 having an exit opening 121. The elongated chamber 120 is typically cylindrical, but may also have other elongated shapes, for example having an elliptical or polygonal section such as hexagonal or rectangular section. The elongated chamber 120 may be separated from the main chamber 101, may be attached to the main chamber 101, may be part of the same structure as the main chamber 101, may be included in the main chamber 101, or may have any other structural relation to the main chamber 101 and/or any part of the main chamber 101. In this example, the elongated chamber 120 is located outside of the main chamber 101, however the elongated chamber may also be located inside the main chamber, as will be discussed further herein.

Capsule 100 also includes a breaker element (protrusion) 122 mechanically mounted in proximity to the exit opening 121. The breaker element 122 may be part of the elongated chamber 120, and/or may be mounted on any element of the capsule 100. For example, the breaker element 122 may be mounted on an end of the elongated chamber 120 or on a side wall of the elongated chamber 120. The breaker element 122 is pointing towards the inside of the elongated chamber 120. The breaker element 122 may have any shape, size or structure, may include one or more sub-elements, and may be made of any material. The breaker element (protrusion) 122 may be shaped, for example, as a cylinder, a sliced cylinder, a tube, a sliced tube, a ridge, a needle, may have a rounded form, and/or may include one or more rods and/or any other structure(s). For example, the breaker element may be a sharp element mounted on the elongated chamber 120 which includes a sharp tip and/or a sharp edge. The breaker element may include one or more protrusions which may push and break a rigid seal. The breaker element 122 may be separated from the elongated chamber 120, may be attached to the elongated chamber 120, or may be part of the same structure as the elongated chamber 120 as shown in the current example. Also, various mechanisms for breaking or piercing may be employed, for example using rotation of a sharp tip.

The elongated chamber 120 is fluidly connected to the main chamber 101 via the exit opening 121. The exit opening 121 may be located at the center of the breaker element 122, for example when the breaker element 122 includes a circular shaped sharp edge and is surrounding the exit opening 121. The exit opening 121 may include a passage 124 which is fluidly connected to the main chamber 101.

Configured within the elongated chamber 120 is a slidable container 130 filled with an ingredient substance. The slidable container 130 has a shape which is fitting the shape of the elongated chamber 120, typically cylindrical. Optionally, the slidable container 130 is inserted into the elongated chamber 120 through an entry opening 123 of the elongated chamber 120. The slidable container 130 is free to slidingly move along the inside of the elongated chamber 120. The slidable container 130 may be free to move in both directions (in this example, the directions are up and down) or may be limited to moving in one direction (in this example, this may be only down), to prevent the slidable container 130 from exiting the elongated chamber 120 through the entry opening 123.

The slidable container 130 (as well as the main chamber 101, the elongated chamber 120, and/or any other component of the capsule 100) may be made of any material, for example, acrylic glass (methyl methacrylate), polyethylene terephthalate glycol, polypropylene, acrylonitrile styrene (acrylate), polystyrene, aluminum, acrylonitrile butadiene styrene, polyethylene, terephthalate, or glass. Different preparations and different raw ingredients require different storage materials, such as chemical resistant materials to acids or bases, bio-safe materials especially for medical and/or nutritional supplements preparations and/or antioxidants or vitamins that need an oxygen barrier to preserve stability. Optionally, an internal face of the slidable container 130, the main chamber 101 and/or other components of capsule 100 may be produced from various materials according to specifications and requirements for storing certain ingredients. Different materials may be used for different slidable containers (and/or other components) within the same capsule. In addition, the structure of the slidable container 130, the main chamber 101 and/or other components of capsule 100 may be designed to withstand internal forces without deformation, for example when viscosity of the substances is high or increased, for example during refrigeration.

The slidable container 130 is sealed by a container piston 131 at a proximal end, and sealed by a breakable seal 132 at a distal end, closer to the exit opening 121 and/or the breaker element 122.

As used in the present disclosure, the term “proximal” refers to a direction closer to the end scaled by the container piston, and the term “distal” refers to a direction closer to the end scaled by the breakable seal.

The container piston 131 fits to slide inside the slidable container 130, and has a shape which is fitting the inside of the slidable container 130, generally cylindrical. The container piston 131 is seating in a fluid-tight fashion against the walls of the slidable container 130. The container piston 131 may be made of any material which allows sealing of the slidable container 130. The material of each container piston may be selected according to the ingredient substance stored inside the respective slidable container.

The breakable seal 132 may be any kind of structure or element which is sealing the distal end of the slidable container 130, and may be broken when pushed, for example by a sharp tip or a rigid element. The breakable seal 132 may be a sheet, a frangible film, a membrane, foil and/or any other thin layer covering a distal opening of the slidable container 130. The breakable seal 132 may also include a rigid part(s) which are detached from other rigid part(s) when the seal is broken. The breakable seal 132 may be any part of the slidable container 130, and may be made from the same material as the slidable container 130, for example a thinner part of a slidable container 130 made by injection moulding.

The breakable seal 132 may be sufficiently resilient to sustain the force exerted on the breakable seal 132 by the ingredient substance. The breakable seal 132 may be designed to be broken when subjected to a predetermined minimum pressure. The breakable seal 132 may be made of any material which allows sealing of the slidable container 130. The material of each breakable seal may be selected according to the ingredient substance stored inside the respective slidable container.

Optionally, the proximal end of the slidable container 130 is further sealed by a top breakable seal, which is positioned on, or over, the container piston 131. The top breakable seal may be broken when the container piston 131 is moved relative to the slidable container 130. This gives extra sealing, for example to prevent air from passing into the slidable container 130, when the container piston 131 is made of a material which may not be air-tight, such as polypropylene.

FIG. 1A shows the capsule 100 at a starting position wherein the ingredient substance is sealed inside the slidable container 130. The process of extracting material from the slidable container 130 into the main chamber 101 includes applying pressure on the container piston 131, shown by an arrow. The pressure may be applied by any mean, for example, by one or more pushing rods of a mixer device into which the capsule 100 is inserted or connected, as described in the above-identified applications.

When pressure is first applied on the container piston 131, so the container piston 131 is pushed distally, the slidable container 130 is slidingly moved inside the elongated chamber 120. This happens because the ingredient substance which is sealed inside the slidable container 130 prevents the container piston 131 from being pushed inside the slidable container 130. When the ingredient substance is non-compressible, the slidable container 130 immediately starts moving distally when the container piston 131 is pushed distally. When the ingredient substance is compressible, the slidable container 130 may first shortly slide into the slidable container 130 while compressing the ingredient substance, and then, when the ingredient substance is compressed, move the slidable container 130 along the elongated chamber 120.

As shown in FIG. 1B, when the slidable container 130 is moved enough inside the elongated chamber 120 so that the breakable seal 132 is reaching the breaker element 122, the breakable seal 132 is broken by the breaker element 122. Optionally, the distal end of the elongated chamber 120 is structured to stop the movement of the slidable container 130 after the breaker element 122 fully breaks the breakable seal 132. For example, the elongated chamber 120 may include a rim 125 around the exit opening 121 and/or the breaker element 122.

As shown in FIG. 1C, when the breakable seal 132 is broken, the ingredient substance is free to move through the exit opening 121, allowing the container piston 131 to be pushed inside the slidable container 130, thereby pushing the ingredient substance through the exit opening 121, and optionally through the passage 124, into the main chamber 101.

Optionally, as shown in FIG. 1D, the container piston 131 reaches the distal end of the slidable container 130 after pushing all of the ingredient substance out of the container piston 131 and substantially into the main chamber 101 to be mixed with other ingredient substance(s).

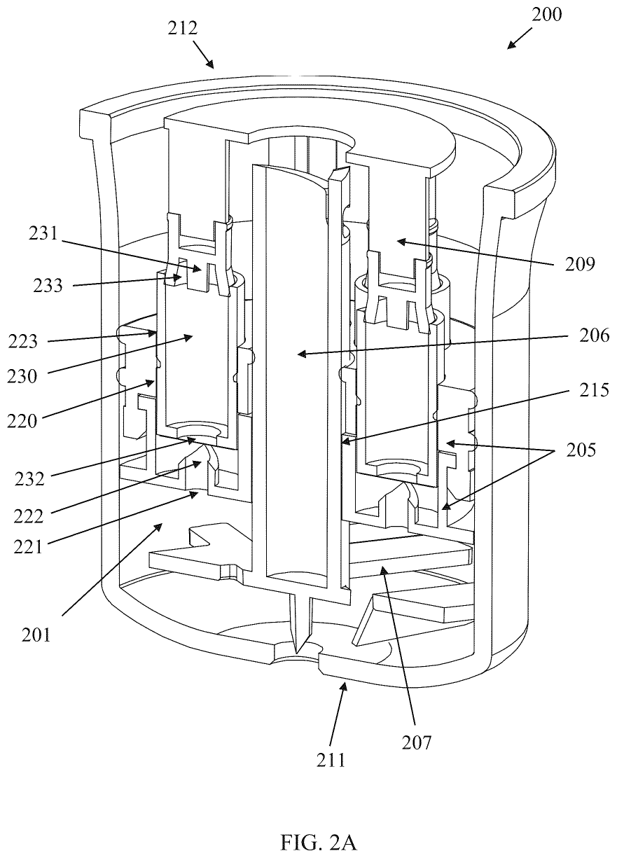

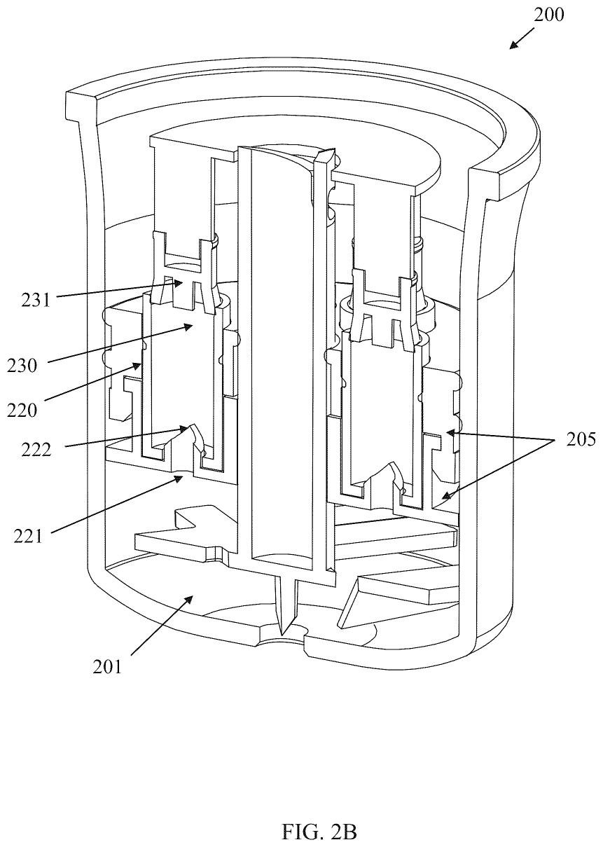

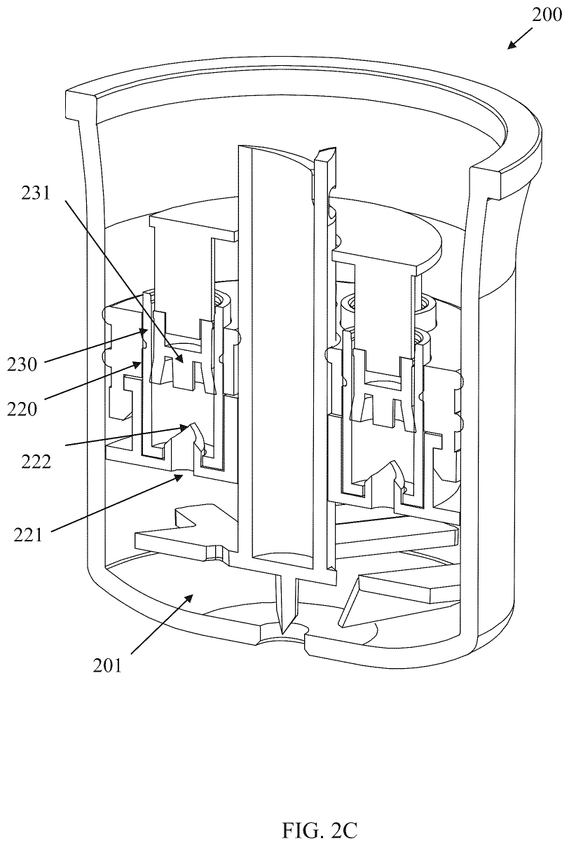

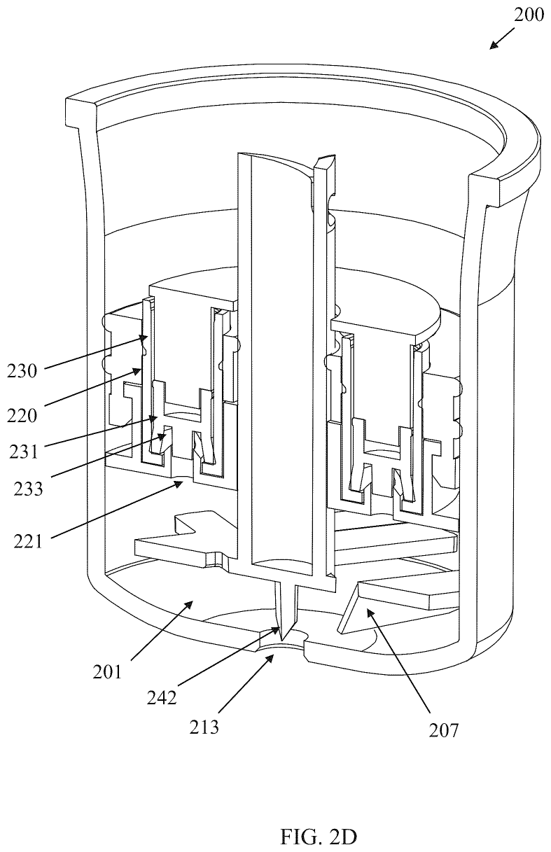

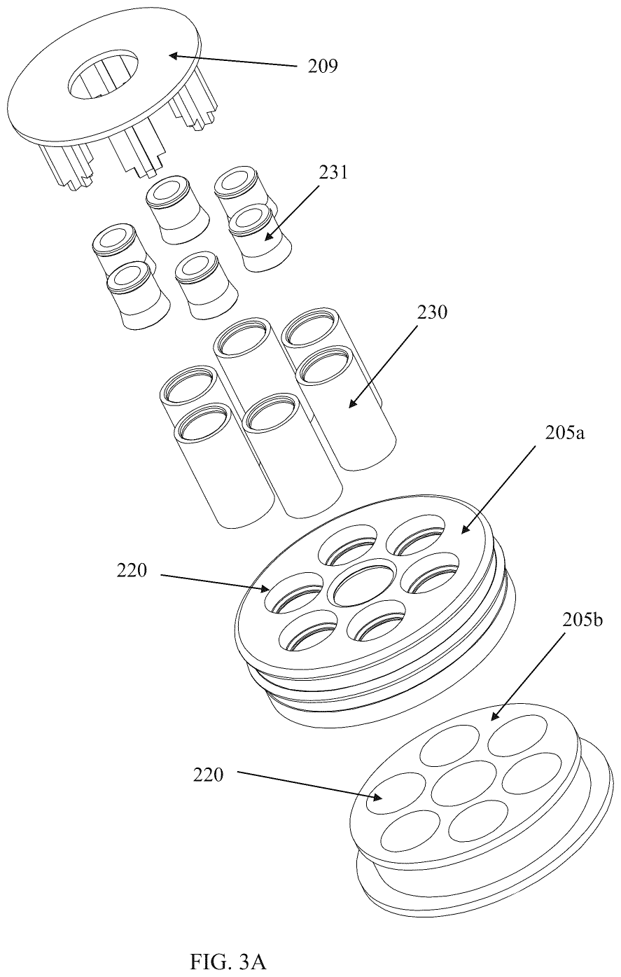

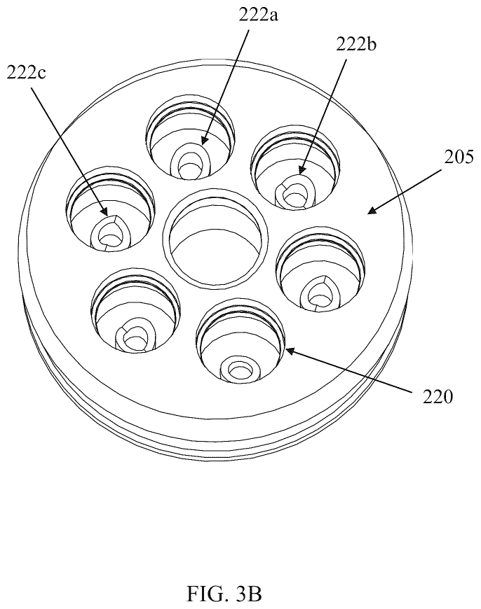

Reference is now made to FIGS. 2A-2D, which are section view drawings of a capsule 200 having internal elongated chambers, according to some embodiments of the present invention. Reference is also made to FIGS. 3A, which is an exploded view of some of the component of the capsule 200, and to FIGS. 3B, which is a top view of the main piston of the capsule 200, according to some embodiments of the present invention.

Main piston 205 includes a plurality of cavities, each cavity is an elongated chamber 220. Within the elongated chambers 220 are slidable containers 230, each filled with an ingredient substance, sealed by a container piston 231 at a proximal end, and sealed by a breakable seal 232 at a distal end.

In this embodiment, as shown at FIGS. 3A, the main piston 205 is comprised of a flexible piston part 205a which is maintaining a fluid seal between the lateral edge of the main piston 205 and the interior face of chamber 201, and a rigid piston part 205b. The elongated chambers 220 are passing through both piston parts 205a and 205b of the main piston 205.

The rigid piston part 205b includes breaker elements, which are the sharp elements 222 of the elongated chamber 220, as shown at FIG. 3B. Three exemplary types of sharp elements 222 shaped as a hollow cylinder are shown. Sharp element 222a is shaped as a hollow cylinder with a bevel tip. Sharp element 222b is shaped as a hollow cylinder which is sliced with two diagonal cuts creating a concave triangular cut. Sharp element 222c is shaped as a hollow cylinder which is sliced with two diagonal cuts creating a convex triangular cut.

The sharp element(s) 222 may be an integral part of the solid structure of the elongated chamber 220, or may be a separate structure disposed inside the elongated chamber 220. The sharp element(s) 222 may be fixated to the structure of the elongated chamber 220 and/or removable from within the elongated chamber 220.

FIG. 2A shows the capsule 200 at a starting position wherein the ingredient substances are sealed inside the slidable containers 230. In a process similar to the process described above for the capsule 100, the container pistons 231 are pushed distally (in this case down).

The container pistons 231 may be pushed by a structure 209, comprising a disc and multiple protrusions. In this embodiment, all the container pistons 231 are depressed simultaneously when the structure 209 is depressed. Alternatively, each container piston 231 is separately pushed.

To prevent the main piston 205 from moving downwards when the container pistons 231 are pushed, counter support force may be applied by the mixer element 207. The mixer rod 206 may be connected to a torque arm of a mixer device, which may move the mixer element 207 upwards from the shown position into a position adjacent to the main piston 205, and may hold the mixer element 207 to prevent the main piston 205 from moving downwards.

Alternatively or additionally, the main piston 205 is pushed up by the mixer element 207 while the structure 209 is held by an outside force, so that the container pistons 231 are pushed relative to the main piston 205.

As shown in FIG. 2B, the slidable containers 230 moved down, so that the breakable seals 232 is broken by the sharp elements 222. FIG. 2C shows the container pistons 231 further inside the slidable containers 230, so some amount of each of the ingredient substances is extracted from the slidable containers 230 through the exit openings 221 into the main chamber 201. FIG. 2D shows the container pistons 231 at a final position when all of the ingredient substances are extracted into the main chamber 201.

To accommodate the hollow cylinder shape of the sharp elements 222, each of the container pistons 231 may include a cavity 233 (also shown in FIG. 2A).

When the all ingredient substances are in the main chamber 201, they may be mixed by the mixer element 207, and then pushed by the main piston 205 to be dispensed through a capsule exit opening 213, as described in the above-identified applications. Mixer element 207 may also include a sharp tip 242 which may be used to penetrate a seal closing opening 213, to permit dispensing of mixed formulation from the main chamber 201.

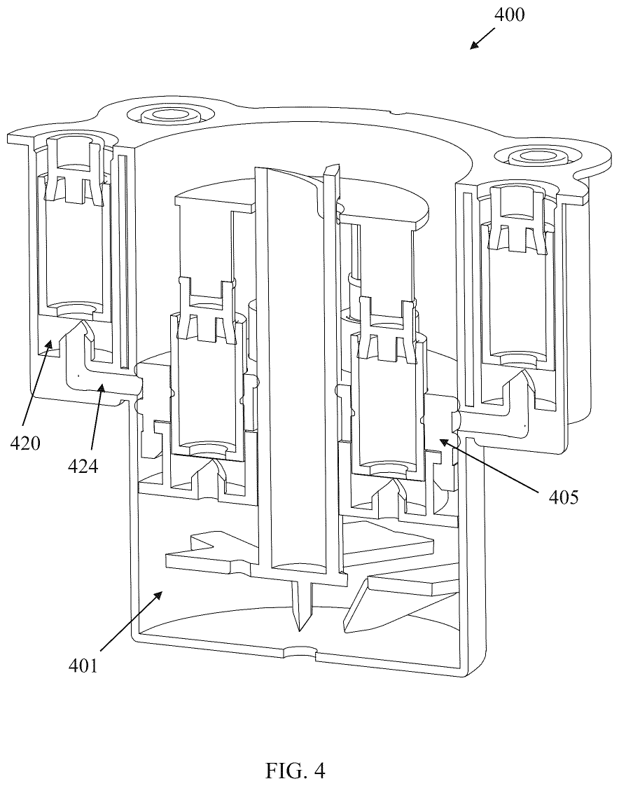

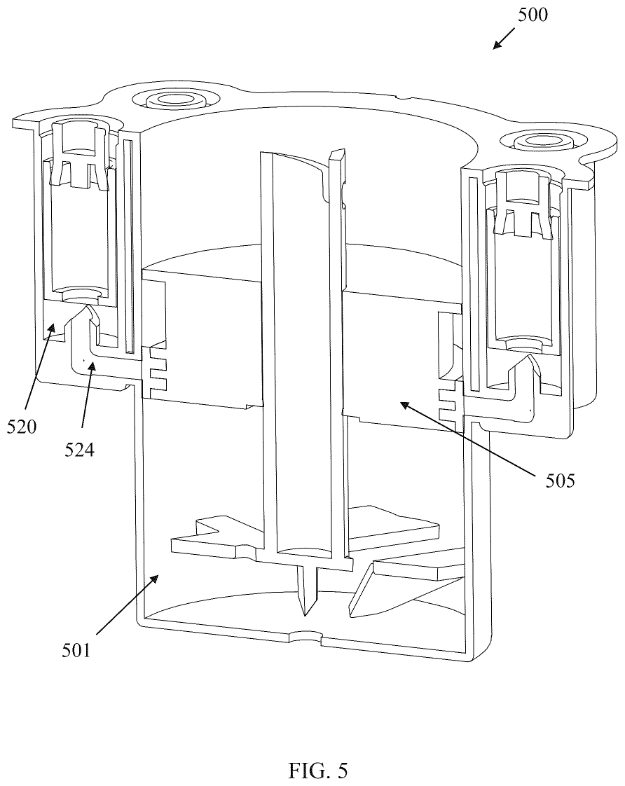

Reference is now made to FIG. 4, which is a section view drawings of a capsule 400 having internal elongated chambers and peripheral elongated chambers, according to some embodiments of the present invention. Reference is also made to FIG. 5, which is a section view drawings of a capsule 500 having only peripheral elongated chambers, according to some embodiments of the present invention.

Capsule 400 may contain a large number of ingredient substances in slidable containers, both inside elongated chambers positioned inside the main chamber 401 and elongated chambers positioned outside the main chamber 401, for example peripheral to the main chamber 401.

In these examples the main pistons 405 and 505, respectively, are sealing the passages 424 and 524 which are fluidly connecting the peripheral elongated chambers 420/520 to the main chamber 401/501. This provides protection for a base substance which is optionally predisposed in the main chamber 401/501, for example against air entering from the peripheral elongated chambers 420/520.

The capsule may also include, in addition to slidable containers inside elongated chambers, repository tubular chambers and/or ingredient receptacle containing ingredient substances, as described in the above-identified applications.

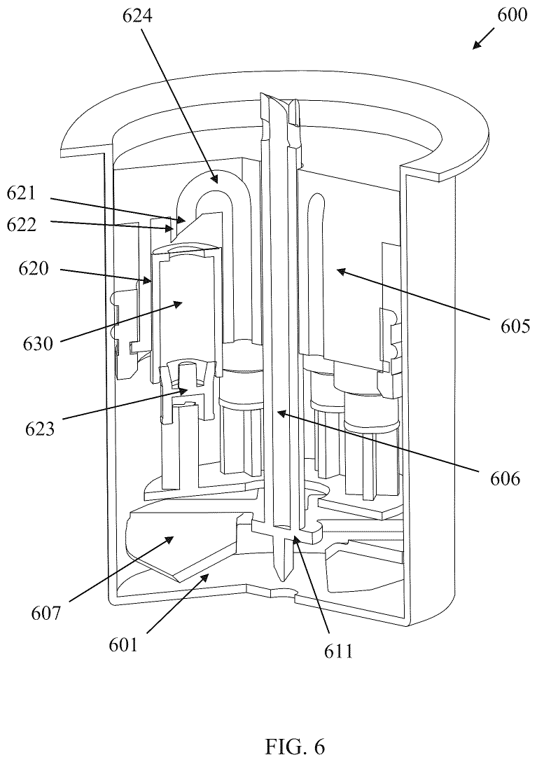

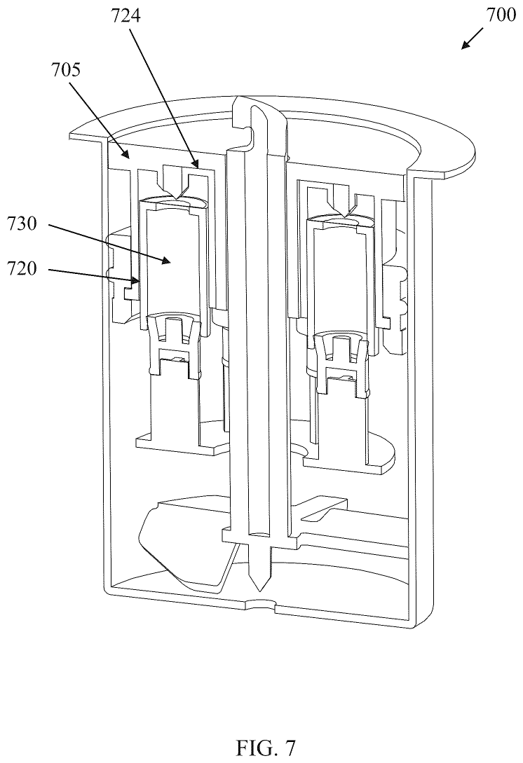

Reference is now made to FIGS. 6 and 7, which are section view drawings of capsules 600 and 700, respectively, having reversed internal elongated chambers, according to some embodiments of the present invention. FIG. 6 shows the capsule 600 with a slice missing, to present internal cuts of a passage 624 as well as the mixer rod 606.

In the capsule 600, the proximal end of the elongated chambers 620 and the proximal end of the slidable containers 630 (the ends which are closer to the container pistons 623) are directed to a second end 611 of the mixer rod 606 wherein the mixer element 607 is disposed. This is unlike the previous embodiments wherein the proximal ends of the elongated chambers and the slidable containers are directed to a first end of the mixer rod, wherein a torque adapter may be disposed.

In this embodiment, the container pistons 623 are pushed upwards, for example by mixer element 607 and optionally via a structure 609. The main piston 605 is held, for example, by pushing rods of a mixer device. Alternatively, the main piston 605 is pushed downwards while the structure 609 is held by mixer element 607.

Since the exit openings 621 are directed up, each of the passages 624 is passing along the elongated chambers 620, from the distal end of the elongated chamber 620 to the proximal end of the elongated chamber 620, and connecting the exit opening 621 to the main chamber 601. In this embodiment, the passages 624 are each located at the side of an elongated chamber 620, in a non-radial position.

This structure is advantageous in that all the ingredient substances, and optionally a base substance predisposed in the main chamber 601, are sealed together inside the capsule 600. This provides extra isolation for the substances as well as the slidable containers 630 themselves, from outside manipulation or damage. Also, more base substance may be predisposed in the main chamber 601, because it may be filled all around the slidable containers 630 and/or the structure 609.

Optionally, as shown in capsule 700, the passage 724 comprises a groove on an inner surface of the elongated chamber 720, adjacent to the slidable container 730. This is easier to produce than a passage 624 which is a tunnel inside the material of the main piston 605. Also, the passage 724 require less space inside the main piston 705, allowing for the main piston 705 to be smaller.

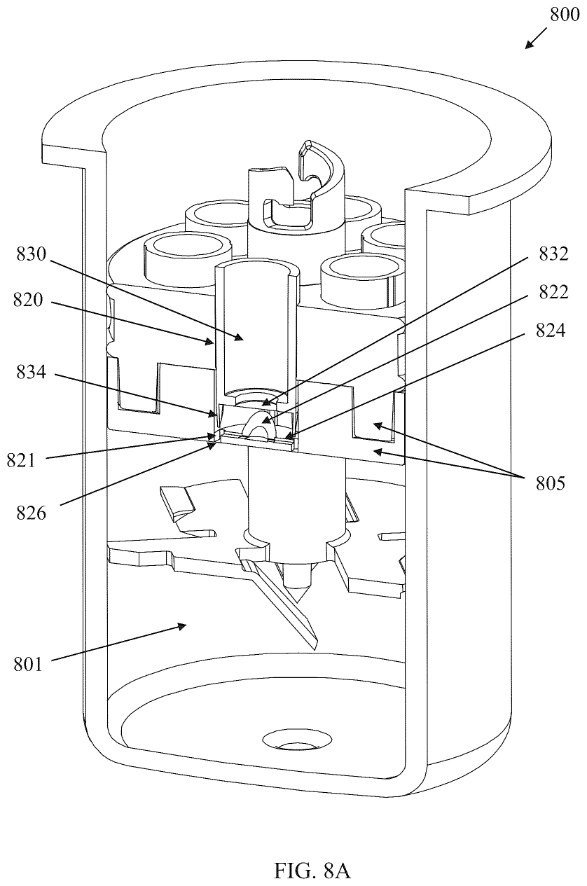

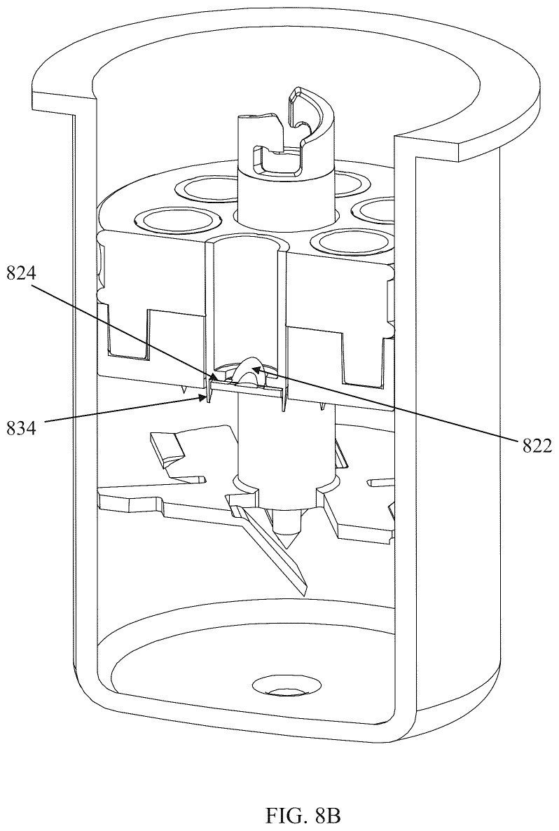

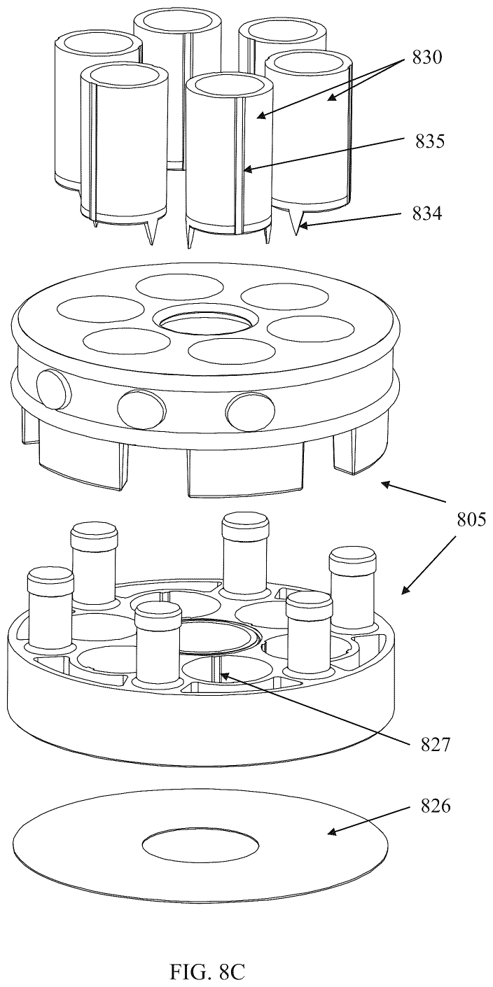

Reference is now made to FIGS. 8A and 8B, which are section view drawings of a capsule 800 having dual seals, according to some embodiments of the present invention. Reference is also made to FIG. 8C, which is an exploded view of some of the component of the capsule 800, according to some embodiments of the present invention.

The exit opening 821 of the elongated chamber 820 is sealed by a chamber breakable seal 826. The chamber breakable seal 826 may be any kind of structure or element which is sealing the exit opening 821 and may be broken by a sharp tip or a rigid element, as described above for breakable seal 132. Optionally, one chamber breakable seal 826 may seal multiple elongated chambers 820, for example a foil ring as shown in FIG. 8C.

The slidable container 830 includes a breaker element, the container sharp element 834, which is pointing towards the chamber breakable seal 826 and is able to break the chamber breakable seal 826. The container sharp element 834 (breaker element) may have any shape, size or structure, may include one or more sub-elements, and may be made of any material, as described above for the breaker element 122.

Optionally, the elongated chamber 820 includes two or more exit openings 821, each sealed by a chamber breakable seal, and the slidable container 830 includes two or more container sharp elements 834.

When the exit openings 821 are sealed, the main chamber 801 is sealed by the main piston 805, even when the slidable containers 830 are not inserted inside the elongated chambers 820.

This allows a base ingredient to be sealed inside the main chamber 801 before the slidable containers 830 are inserted. The advantage of this is the ability to separate the action of filling the base ingredient from the action of inserting the slidable containers 830, thereby making the process of preparing the capsule easier and cheaper, as described above.

As shown in FIGS. 8B, when the slidable container 830 is moved downwards, the chamber breakable seal 826 is broken by the container sharp element 834, while simultaneously or sequentially the container breakable seal 832 is broken by the chamber sharp element 822.

Optionally, the slidable container 830 includes an alignment element, for example grooves 835, which are fitting to an alignment element of the elongated chamber 820, such as protrusions 827. The alignment elements provide guidance for the slidable container 830, so the container sharp element 834 is aligned with the exit opening 821.

Optionally, the chamber breakable seal 826 includes a notch, which acts as a channel and allows the ingredient substance to flow through the exit openings 821 when the chamber breakable seal 826 is inside the exit openings 821.

Optionally, the elongated chamber 820 includes channels 824 which allow the ingredient substance to flow from the slidable container 830 to the exit openings 821. The channels 824 may comprise grooves on rim of the elongated chamber 820 around the exit opening 821

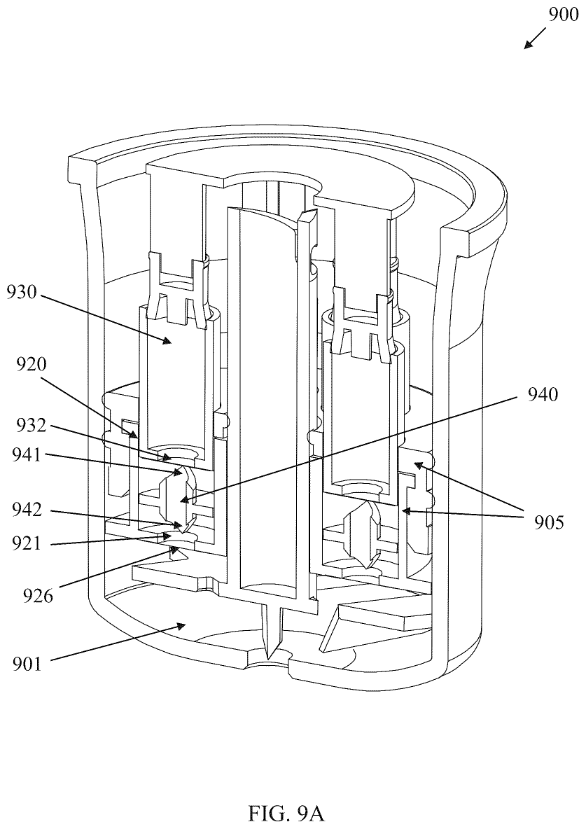

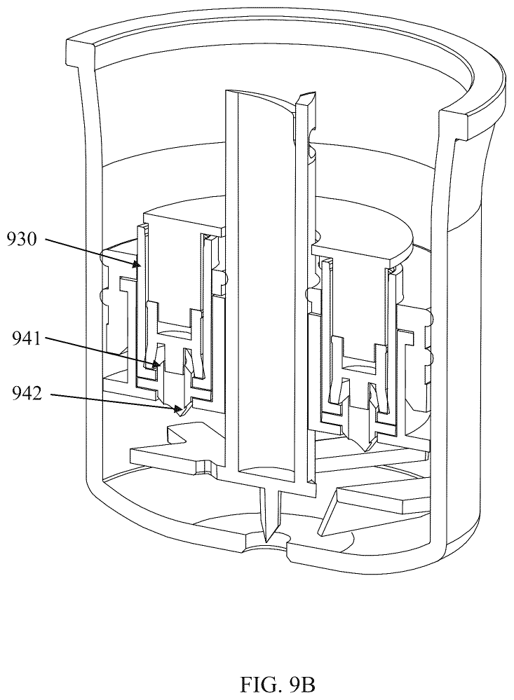

Reference is now made to FIGS. 9A and 9B, which are section view drawings of a capsule 900 having a sharp element structure, according to some embodiments of the present invention.

A sharp element structure 940 is disposed between the breakable seal 932 of slidable container 930 and the exit opening 921 of the elongated chamber 920, which is sealed by a chamber breakable seal 926. The sharp element structure 940 includes a first sharp element 941, which is pointing towards the container breakable seal 932, and a second sharp element 942, which is pointing towards the chamber breakable seal 926.

As shown in FIGS. 9B, when the slidable container 930 is moved downwards, the container breakable seal 932 is broken by the first sharp element 941, while the chamber breakable seal 926 is broken by the second sharp element 942. The seals may be broken simultaneously, or one seal may be broken before the other.

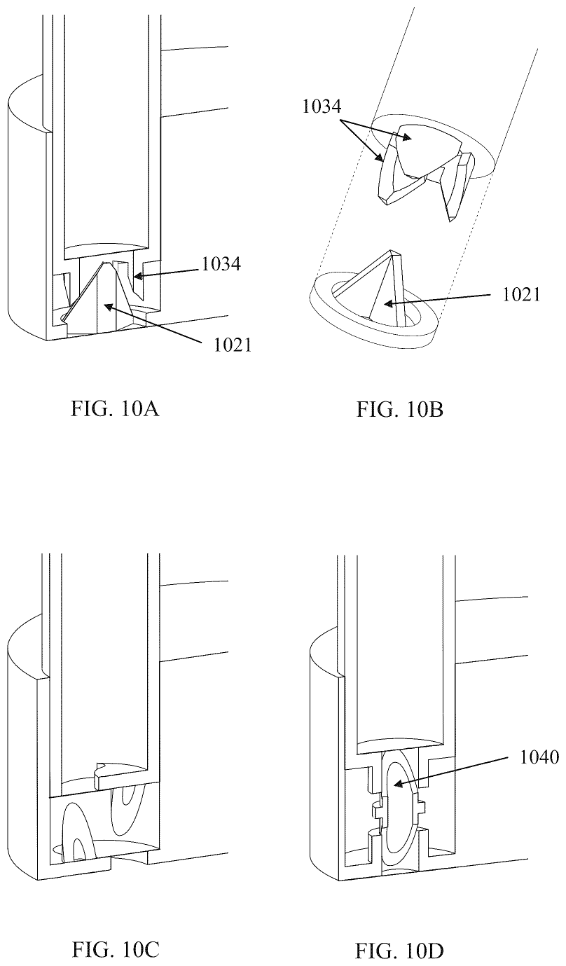

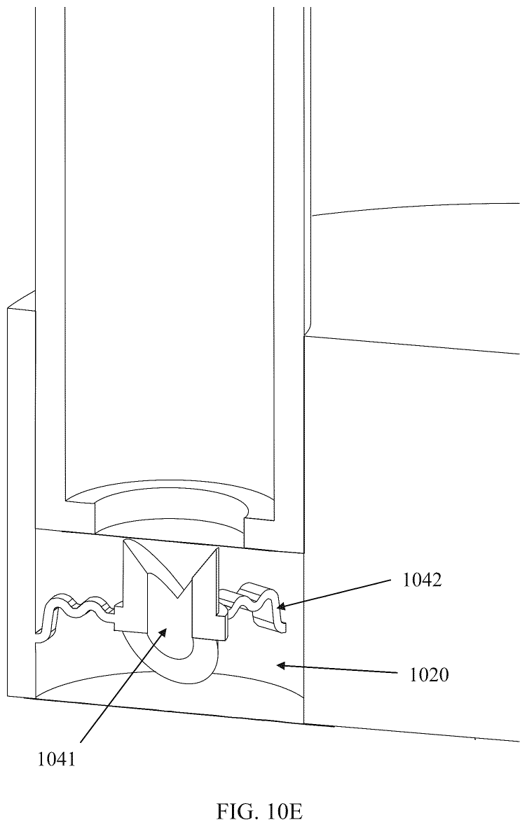

Reference is now made to FIGS. 10A, 10B, 10C, 10D and 10E, which are drawings of exemplary configurations of breaker elements and breakable seals, according to some embodiments of the present invention. FIGS. 10A, 10B show a mechanism of chamber breaker element 1021a having triangular shape, and three container breaker elements 1034 which may be inserted between the edges of the chamber breaker element 1021. FIG. 10C shows breaker elements which are sharp elements positioned side by side. FIG. 10D shows a breaker element structure 1040, similar to the sharp element structure 940. FIG. 10E shows a breaker element structure 1041 which is mechanically connected to the elongated chamber 1020 via flexible arms 1042, which are holding the breaker element structure 1041 in place while allowing the breaker element structure 1041 to flexibly move downwards to break the breakable seals.

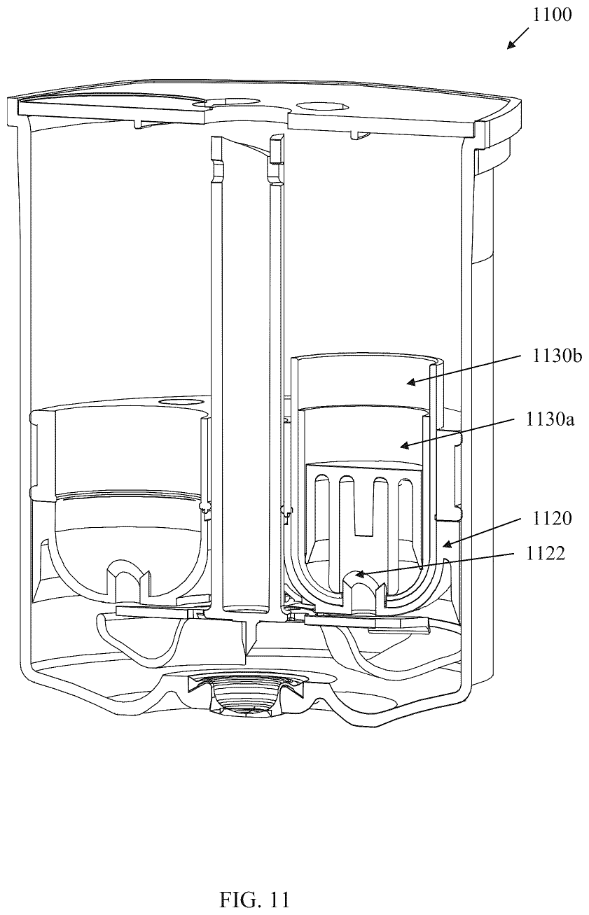

Optionally, slidable containers of different widths may be used inside elongated chambers of the same size. This is advantageous when using the same capsule for different amounts of ingredient substances. This may be done, for example, by inserting one container into another container. Reference is now made to FIG. 11, which is a section view drawing of a capsule 1100 having a small container 1130a inside a large container 1130b. In this configuration, the large container 1130b is stationary, and acts as part of the elongated chamber 1120, while the small container 1130a is sealed by a breakable seal and slidable inside the large container 1130b. When a larger amount of ingredient substance is needed, the large container 1130b is sealed by breakable seal and slidable inside the elongated chamber 1120.

Optionally, a breaker element structure may be connected to the large container 1130b, to break the breakable seal of the small container 1130a and a seal of the exit opening of elongated chamber 1120, as described above for sharp/breaker element structures.

Optionally, the small container 1130a and the large container 1130b are each sealed by a breakable seal. The large container 1130b may be initially positioned so that the breakable seal at the bottom of the large container 1130b is above the breaker element 1122, optionally adjacent to the breakable seal at the bottom of the small container 1130a. When the small container 1130a is pushed, the breakable seal of the large container 1130b may be broken by the breaker element 1122. Optionally, when the containers have a cylindrical shape, the breakable seal of the large container may also be broken by the body of the small container.

It is expected that during the life of a patent maturing from this application many relevant motors, clamps, and actuators will be developed that are suitable for the functions described herein, and the scope of the terms motor, clamp, and actuator is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A capsule for mixing multiple substances, comprising:
a main chamber (101);
a main piston (105) fitted in the main chamber (101);
a mixer rod (106) which is passing through the main piston (105);
a mixer element (107) disposed at an end of the mixer rod (106);
an elongated chamber (120) having an exit opening (121) and sized for containing a slidable container (130) filled with an ingredient substance; and
a protrusion (122) mechanically mounted in proximity to the exit opening (121);
wherein when a container piston (131) of the slidable container (130) is pushed, the slidable container (130) is slidingly moved inside the elongated chamber (120) to be broken by the protrusion (122); and
wherein when the container piston (131) is further pushed, the container piston (131) is moved inside the slidable container (130) thereby pushing the ingredient substance through the exit opening (121) of the elongated chamber (120) into the main chamber (101) for mixing by the mixer element (107).

2. The capsule of claim 1, wherein the container piston (131) is sealing one end of the slidable container (130) and a breakable seal (132) is sealing another end of the slidable container (130), and wherein the breakable seal (132) is broken by the protrusion (122).

3. (canceled)

4. The capsule of claim 1, wherein the protrusion (122) is positioned at a distal end of the elongated chamber (120).

5. The capsule of claim 1, wherein the protrusion (122) is pointing towards the inside of the elongated chamber (120).

6. The capsule of claim 1, wherein the protrusion (122) is a sharp element which includes at least one of a sharp tip and a sharp edge.

7. The capsule of claim 1, wherein the at least one elongated chamber (120) is fluidly connected to the main chamber (101) via the exit opening (121).

8-13. (canceled)

14. The capsule of claim 1, wherein the at least one elongated chamber (120) is peripheral to the main chamber (101).

15. The capsule of claim 1, wherein the main piston (105) comprises a plurality of cavities, each cavity is one of the elongated chambers (120).

16-19. (canceled)

20. The capsule of claim 1, wherein the protrusion (122) is disposed inside the elongated chamber (120).

21. The capsule of claim 1, wherein the container piston (131) includes a cavity shaped to accommodate the protrusion (122).

22. (canceled)

23. The capsule of claim 1, wherein the protrusion (122) is breaking a sheet covering a distal opening of the slidable container (130).

24-25. (canceled)

26. The capsule of claim 1, wherein the container piston (131) is sealing a proximal end of the slidable container (130), a breakable seal (132) is sealing a distal end of the slidable container (130), and the container piston (131) is pushed distally.

27. The capsule of claim 26, wherein the exit opening (121) is located at a distal end of the elongated chamber (120) relative to the slidable container (130).

28. The capsule of claim 1, wherein the elongated chamber (120) further includes an entry opening (123) wherein the slidable container (130) is inserted.

29-30. (canceled)

31. The capsule of claim 1, wherein the exit opening (121) of the elongated chamber (120) is sealed by a chamber breakable seal.

32. The capsule of claim 31, wherein the slidable container (130) includes a container protrusion pointing towards the chamber breakable seal, so when the slidable container (130) is slidingly moved inside the elongated chamber (120), the chamber breakable seal is broken by the container protrusion.

33. The capsule of claim 1, wherein the elongated chamber (120) includes a breaker element structure disposed therein, the breaker element structure includes the protrusion (122) on one end, and a second protrusion on another end.

34. The capsule of claim 1, wherein the movement of the container piston (131) along the slidable container (130) is parallel to the movement of the main piston (105) along the main chamber (101).

35. A method for mixing multiple substances, comprising:
pushing a container piston (131) of a slidable container (130) filled with an ingredient substance, so that the slidable container (130) is slidingly moved inside an elongated chamber (120), and a protrusion (122) mechanically mounted in proximity to an exit opening (121) of the elongated chamber (120) is breaking the slidable container (130); and
further pushing the container piston (131) so that the container piston (131) is moved inside the slidable container (130), and thereby pushing the ingredient substance through the exit opening (121) into a main chamber (101) of a capsule (100);
wherein the capsule (100) includes a main piston (105) fitted in the main chamber (101), a mixer rod (106) which is passing through the main piston (105), and a mixer element (107) disposed at an end of the mixer rod (106).

36. A mechanism for dispensing substances, comprising:
an elongated chamber (120) having an exit opening (121) and containing a slidable container (130) filled with an ingredient substance; and
a protrusion (122) mechanically mounted in proximity to the exit opening (121);
wherein when a container piston (131) of the slidable container (130) is pushed, the slidable container (130) is slidingly moved inside the elongated chamber (120) so that the slidable container (130) is broken by the protrusion (122); and
wherein when the container piston (131) is further pushed, the container piston (131) is moved inside the slidable container (130) thereby pushing the ingredient substance through the exit opening (121) of the elongated chamber (120) into a main chamber (101) of a capsule (100);
wherein the capsule (100) includes a main piston (105) fitted in the main chamber (101), a mixer rod (106) which is passing through the main piston (105), and a mixer element (107) disposed at an end of the mixer rod (106).
